(19) United States
(12) Patent Application Publication
(10) Pub. No.: US 2020/0179198 A1
(43) Pub. Date: Jun. 11, 2020

(54) PORTABLE ASSISTIVE DEVICE FOR USE IN SITTING AND STANDING

(71) Applicant: Justine Lynch Bolduc, Buxton, ME (US)

(72) Inventor: Justine Lynch Bolduc, Buxton, ME (US)

(21) Appl. No.: 16/708,479

(22) Filed: Dec. 10, 2019

Related U.S. Application Data
(60) Provisional application No. 62/777,810, filed on Dec. 11, 2018.

(51) Int. Cl. A61G 5/14; A47C 7/62

(52) U.S. Cl. CPC A61G 5/14; A47C 7/62

(57) ABSTRACT

A portable assistive device that is primarily for use with chairs that do not have armrests, such as kitchen or dining room chairs, comprising at least two support members, with at least one support member removably attachable to either side of the chair.

### BACKGROUND INFORMATION

### Field of the Invention

The invention is a portable assistive device that relates to devices that assist a user in standing from a seated position, and that further relates to armrests that are portable and may be used with a variety of chairs that do not have armrests.

### Discussion of Prior Art

Arms or armrests on chairs generally provide a degree of comfort for a person sitting in a chair but for those with disabilities or declining strength, armrests also assist the person in the act of standing. In these later situations, the armrests not only provide a measure of comfort while sitting, but provide a very important safety mechanism, assisting people in the act of standing and allowing them to stabilize themselves in a standing position before walking away and aiding in the prevention of falls.

There are a number of devices that are intended to assist users in standing from a seated position. For example, a ceiling-to-floor safety pole may be installed in front of a chair to provide users with a stabilized device that they may use to pull themselves up from a seated position. Certain conventional walkers may also be used, or modified to be used, in a similar manner whereby a user may position the walker in front of himself/herself and pull himself/herself up from a seated position. In both instances, the devices are undesirable because the pulling action is ineffective, biomechanically incorrect, and potentially dangerous. The safety pole is further disadvantageous as it is a fixed installation that is cumbersome, expensive, likely to be an obstacle in front of the chair, and may come unattached at either end with excessive force. The walker is further disadvantageous in that there must be space in front of the user to position the walker and because it lacks a degree of stability as a walker will tip backwards towards the user when he attempts to pull himself up unsuccessfully.

Alternatively, there are also are armrests that may be affixed directly to a chair, such as those disclosed in U.S. Pat. No. 6,050,644 (“Neal”). Neal discloses a portable set of armrests that are affixed to a seating surface, wherein the seating surface may be placed in a chair or other sitting device, and secured in position by a strap. While this device does not have the same disadvantages of the pole and walker described above, it lacks the stability necessary to support most users as they rise to a standing position. It is also limited to fitting on devices that have the required sitting area and that allow a strap to be placed under the seat surface of the chair to secure the device in position. Further, where the device is affixed to the seat of the chair the width of the device is inherently limited, and therefore it is not able to accommodate people of a larger size/girth.

What is needed, therefore, is a portable assistive device that may be used with any type of chair without occupying an undue amount of space, without being an awkward structure, and that is still able to provide the necessary stability to assist a user in safely rising from a seated position to a standing position.

### BRIEF SUMMARY OF THE INVENTION

The invention is a portable assistive device that is primarily for use with chairs that do not have armrests, such as kitchen or dining room chairs, by people who have a difficult time standing up from a seated position. It is an assistive device that provides a mechanism for people to use their arms in a mechanically advantageous way in order to stand up from a chair without assistance. It is effective for the growing baby boomer population and, especially for those senior citizens who find it harder and harder to do some of the every-day activities of daily living like standing up from the kitchen table.

The assistive device is easily attached to and adjusted on an armless chair, providing its users with the independence to stay at home in today's ever changing, cost-cutting, healthcare world. More specifically, it is a portable set of armrests that securely attaches to an armless chair and provides a stable surface, at an optimum height, on both sides of a chair for a user's hands to hold onto and push up from during transfers, e.g. standing up from or sitting down on a chair and helping to prevent falls.

This device is designed with at least four legs which extend from the armrests all the way to the floor, providing an exceptional support structure for the downward forces that are applied during the process of standing up. The device enables a person, especially one of decreased strength and/or increased age, to safely complete one of the most common activities of daily living and, ultimately, remain in the home longer than if he/she were unable to stand up from a chair without some form of assistance.

In general, the assistive device is inserted around a chair from the back side of the chair, with the four legs extending downwards from the body of assistive device near the conventional position of the four legs on the chair. Easily adjustable and removable attachment mechanisms are provided to secure the assistive device to the chair. Adjustable crossbars extend from one side of the device to the other for added stability.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a top perspective view of the portable assistive device according to the invention where the device is connected to a chair and ready for use.

FIG. 2 is a front and side perspective view of the device.

FIG. 3 is a rear view of the device.

FIG. 4 is a side view of one support member not attached to chair.

FIG. 5 is a bottom view of the device attached to a chair.

FIG. 6 is a front view of a second embodiment of the device attached to a chair.

FIG. 7 is a right side view of the second embodiment.

FIG. 8 is a left side view of the second embodiment.

FIG. 9 is a rear view of the second embodiment.

FIG. 10 is a front and side perspective view of a third embodiment of the device affixed to a chair.

FIG. 11 is a side view of a fourth embodiment showing rounded support members.

FIG. 12 is a top and side perspective view of a fifth embodiment.

FIG. 13 is a rear view of the device having a support bar connecting the rear legs.

FIG. 14 is a side view of the device having a support bar connecting the side legs.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

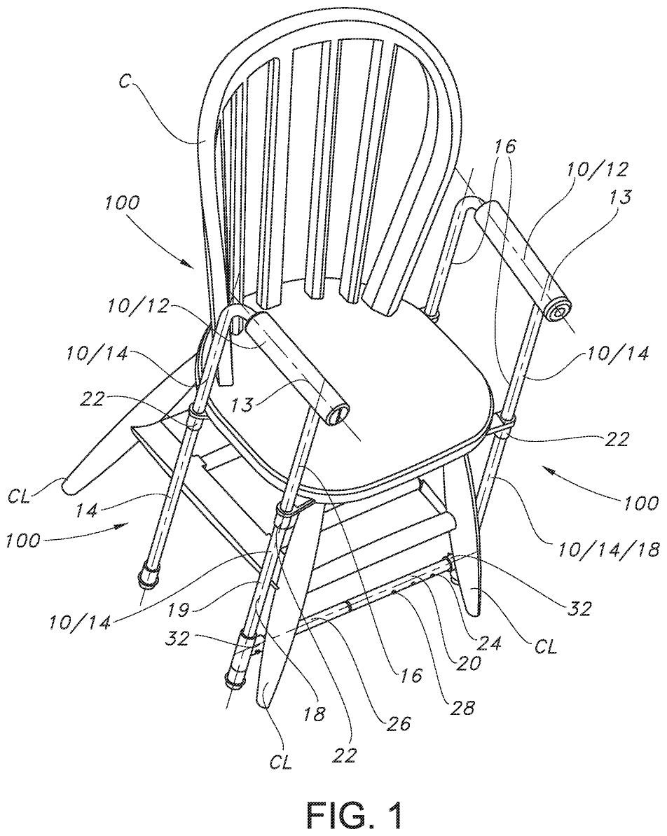

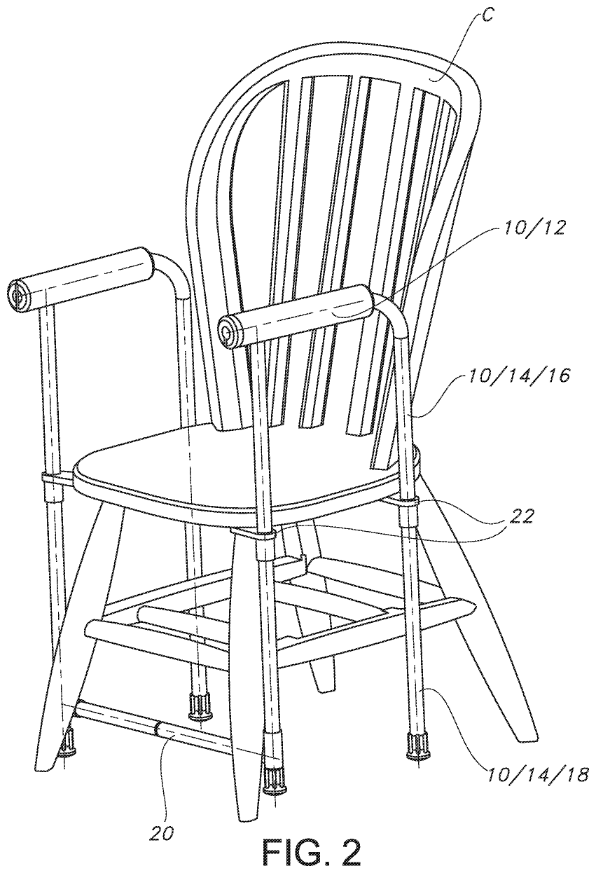

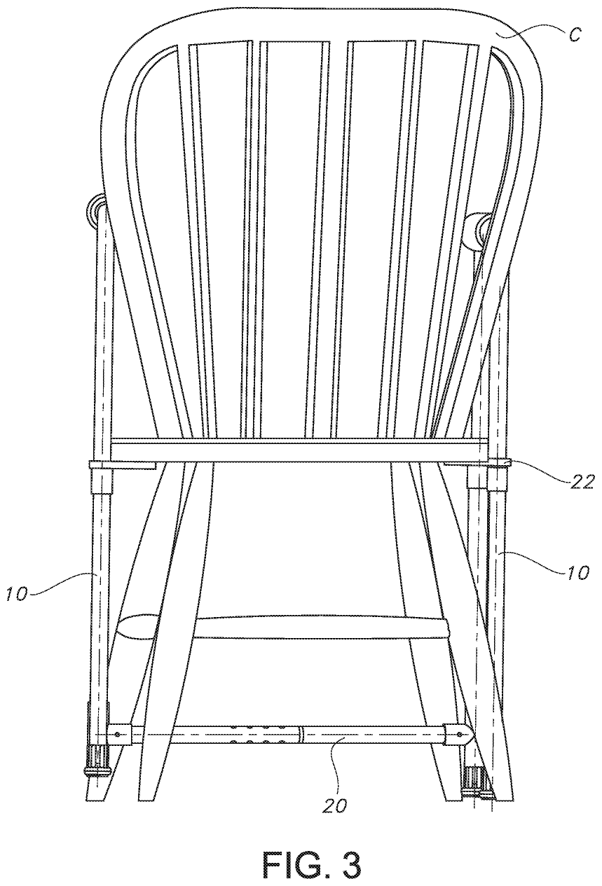

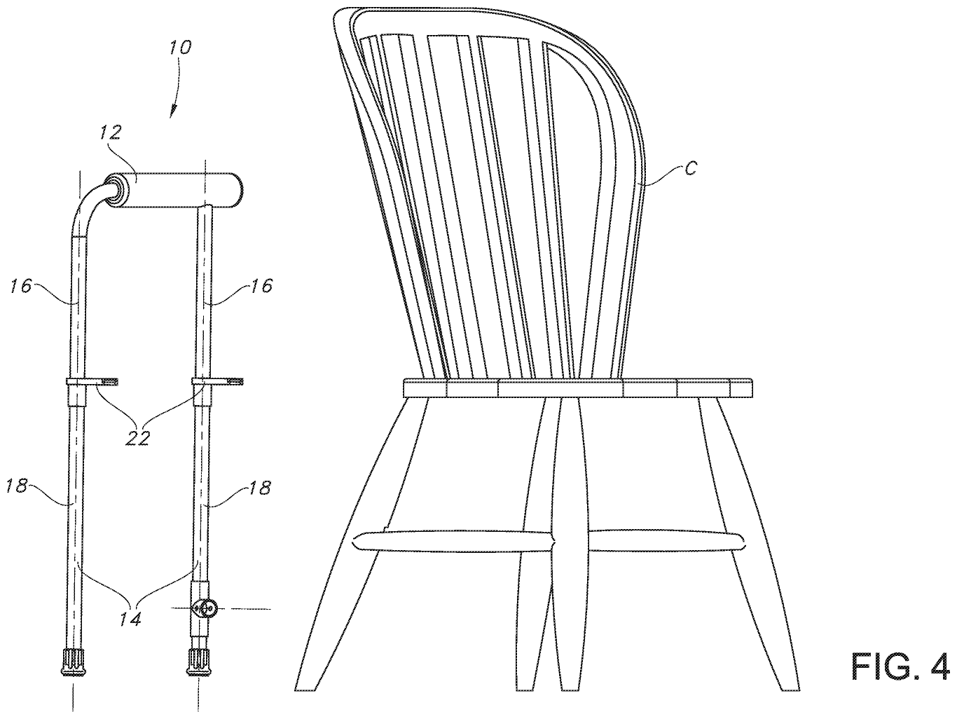

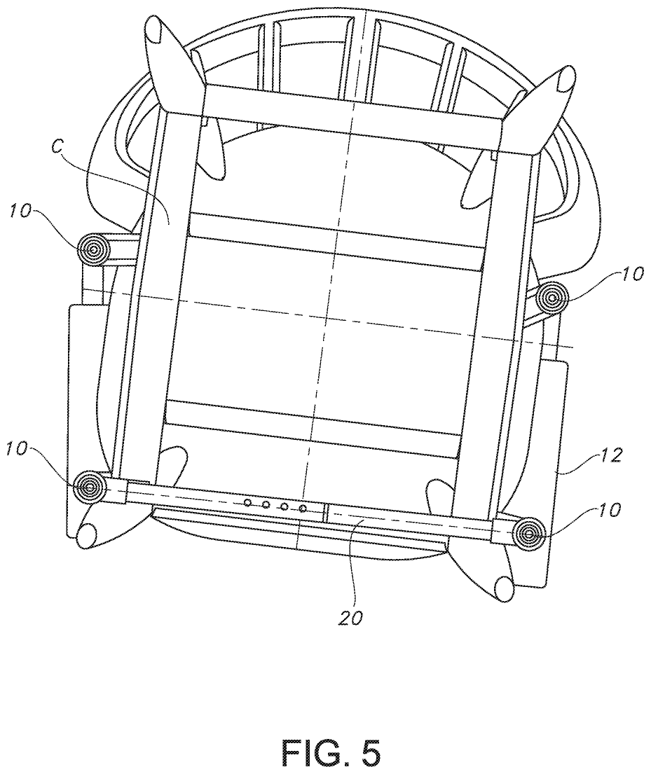

FIGS. 1-5 show a first embodiment of the portable assistive device 100 according to the invention including two support members 10 that are attachable to a chair C and connected to one another by one or more cross bars 20. The support members 10 each include an upper connector 12 and two legs 14. The support members 10 are affixed to the chair C by one or more attachment mechanisms 22.

Once the portable assistive device 100 is attached to the chair C and the legs 14 are adjusted to the desired height the device 100 securely provides a stable surface, at an optimum height, on both sides of the chair C for a user's hands to hold onto and push upward during a transfer, e.g. standing up from or sitting down on a chair, allowing a user to safely rise or sit as desired without further assistance. In general, while the height of the support members is adjustable with most embodiments, the armrests are usually positioned between 3 and 12 inches above the surface of the chair seat.

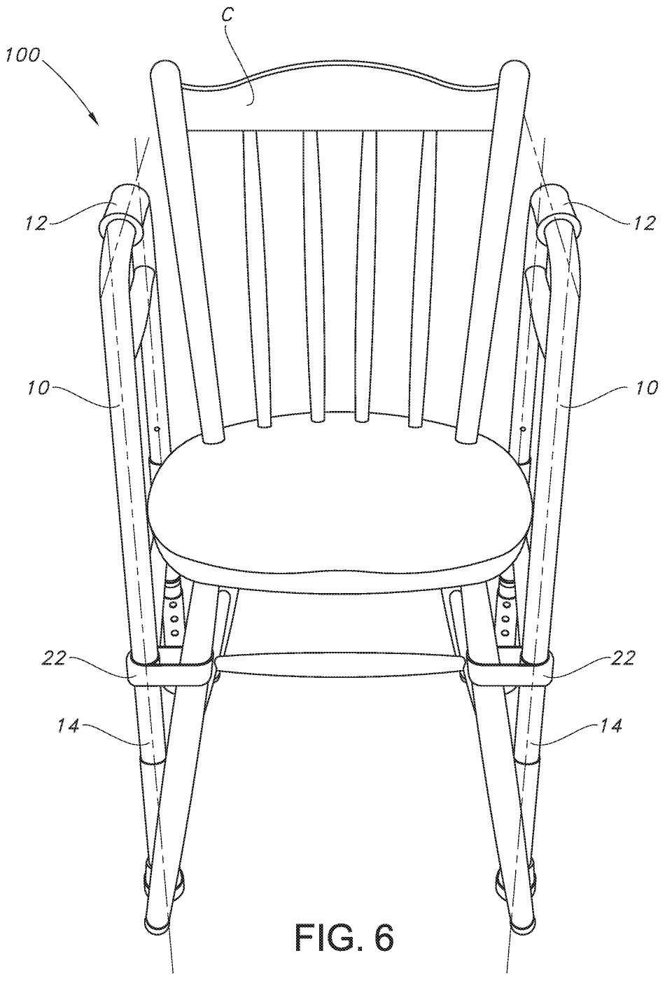

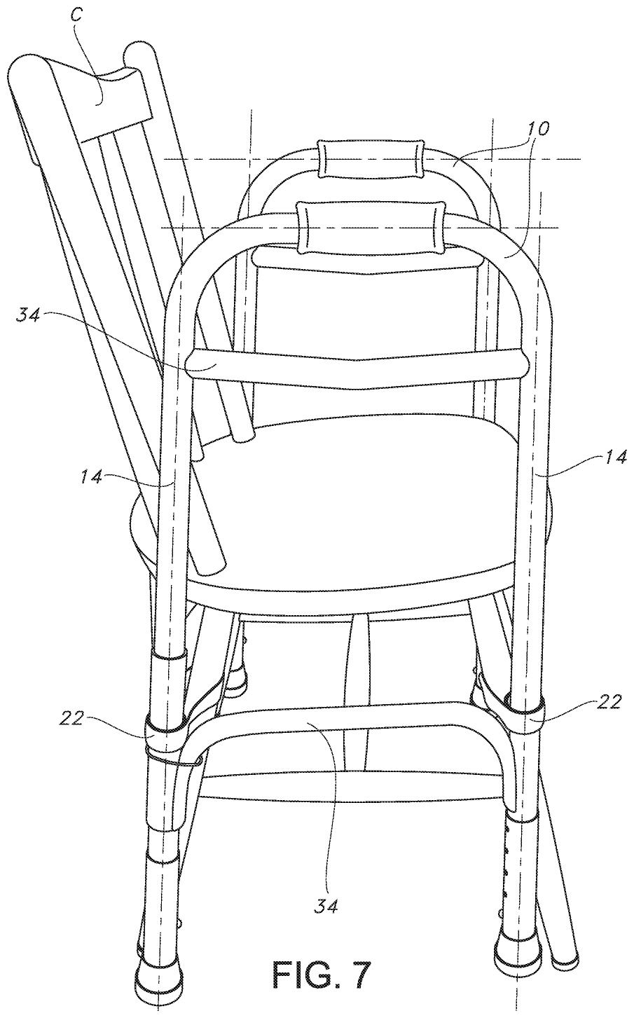

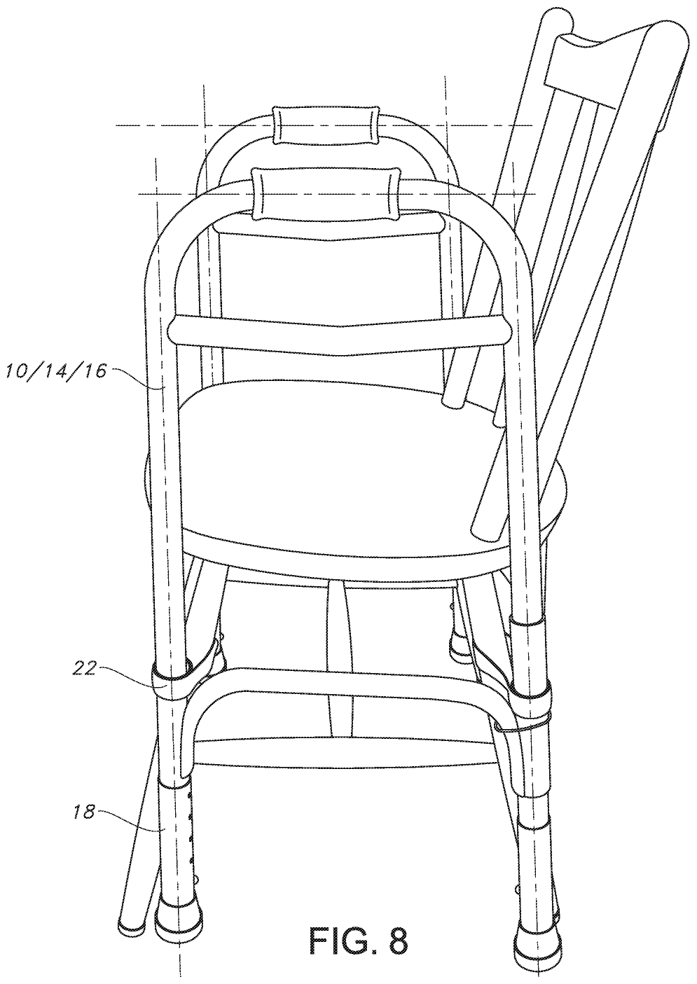

The support members 10 may be attached to the chair C using a number of conventional mechanisms. In the embodiment shown, the attachment mechanisms are conventional clamping devices that are affixed to the each leg 14 and then clamped to each chair leg CL. More or fewer attachment mechanisms may also be deployed depending on the design of the chair C. Alternative forms of attachment mechanisms 22 include but are not limited to straps and/or cords, as shown in FIGS. 6-9, each of which may be tied or include hook and loop fasteners, or strap and buckle devices.

As mentioned, the support members 10 may also be connected to one another by one or more support bars 20. In the first embodiment shown, one support bar 20 connects the front legs 14 of the support members 10 approximately two inches above the bottom of the legs 14. The support bar 20 or support bars 20 still provide a measure of support when positioned between the rear legs 14, between the side legs 14, or at a higher position along the support legs 14.

The support bar 20 may also be adjustable. For example, the support bar 20 may include two slidably interlocking tubes 24, 26 with locking pins 28. This allows for the width of the portable assistive device 100 to be adjusted to fit a wide variety of chairs. Locking pins 32 may be used to connect each end of the support bar 20 to a leg 14 on the support member 10, such that the support bar 20 may be removed entirely when the device is not in use so that it is more portable. Other conventional securing means such as, for example, screws and/or nuts and bolts may also be used in lieu of or in addition to the locking pins.

The legs 14 are adjustable in height, and include interlocking tubes, an upper tube 16 and a lower tube 18, the upper tube 16 being adjustably inserted into the lower tube 18 and secured in the desired height/position and using a locking pin 19. Other conventional means such as, for example, screws and/or nuts and bolts may also be use in lieu of or in addition to the locking pins 19.

The upper connectors 12, also referred to as armrests, are shown as an integral portion of the support member 10, having a padded cover 13 for the user's comfort. In other embodiments, the arm rests 12 may be removably connected to the legs 14 using a number of conventional means, such as, for example, locking pins and/or nuts and bolts. Removable armrests 12 make the portable assistive device 100 easier to transport in a disassembled state.

FIGS. 6-9 illustrate a second embodiment of the device 100. In this embodiment, the two support members 10 are attached to one another using a pair of cross bars 20 that are positioned behind the rear legs of the chair C. Each of the front legs 14 and rear legs 14 are secured to the chairs legs using straps, for example, straps having hook and loop fasteners for quick and easy attachment to the chair.

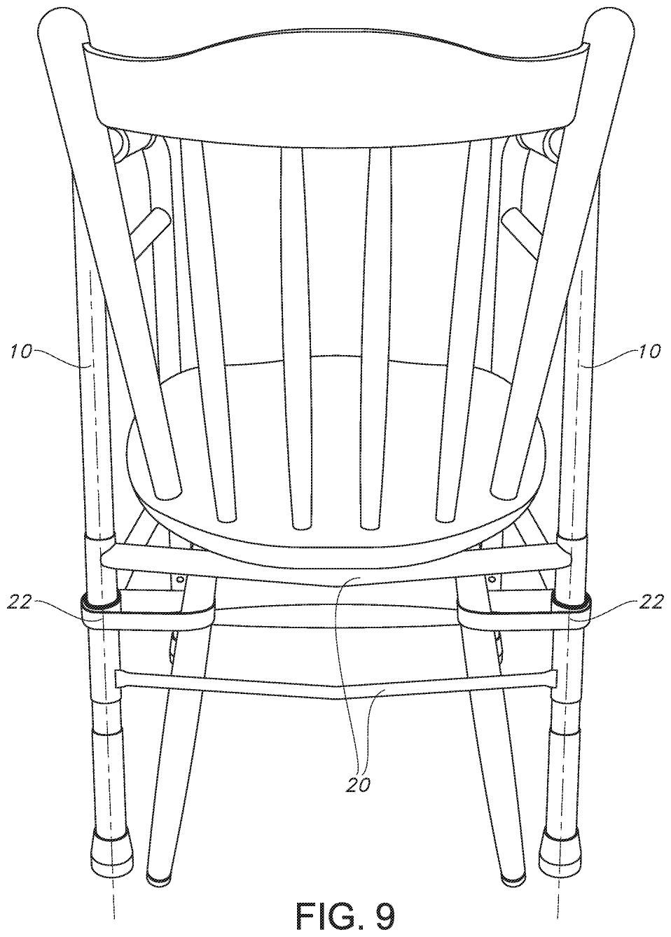

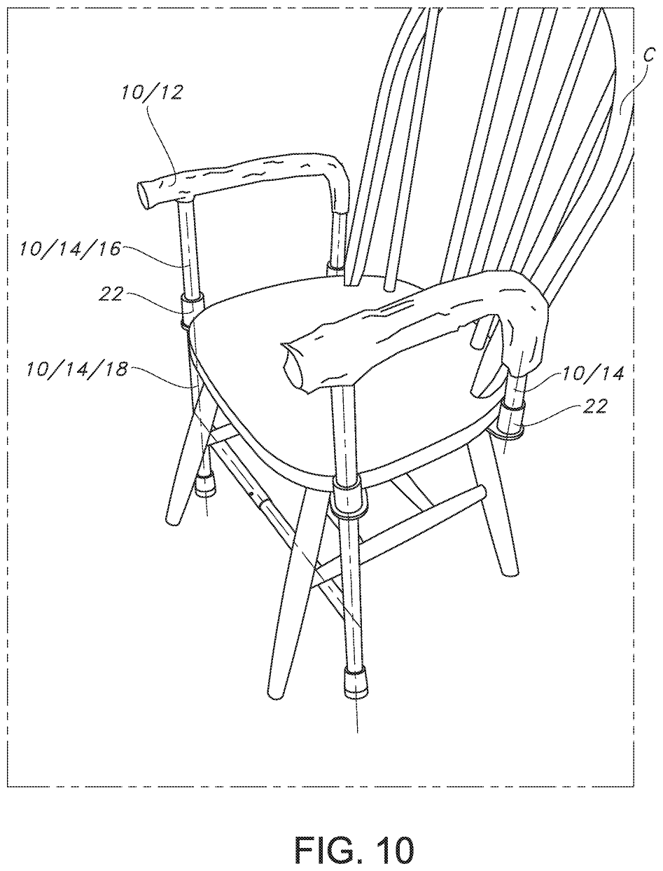

FIG. 10 illustrates a third embodiment of the device 100 where the support members have front legs 14 that extend all the way to the floor and rear legs 14 that attach to the chair C and do not extend all the way to the floor.

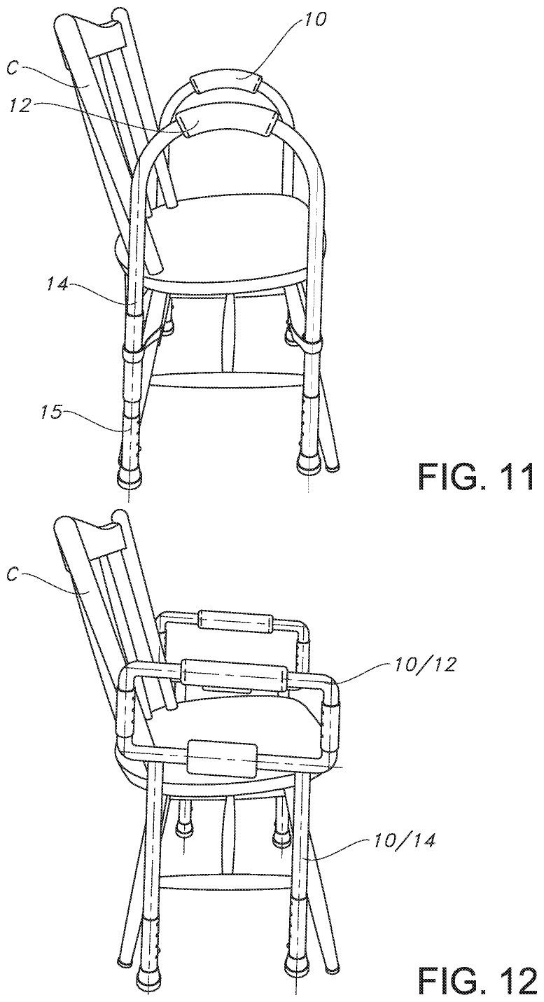

FIG. 11 illustrates a fourth embodiment of the device 100 where the support members 10 are curved and have adjustable feet 15 at the end of each leg 14.

FIG. 12 illustrates a fifth embodiment of the device 100 where the legs 14 and armrest 12 are separably adjustable in height.

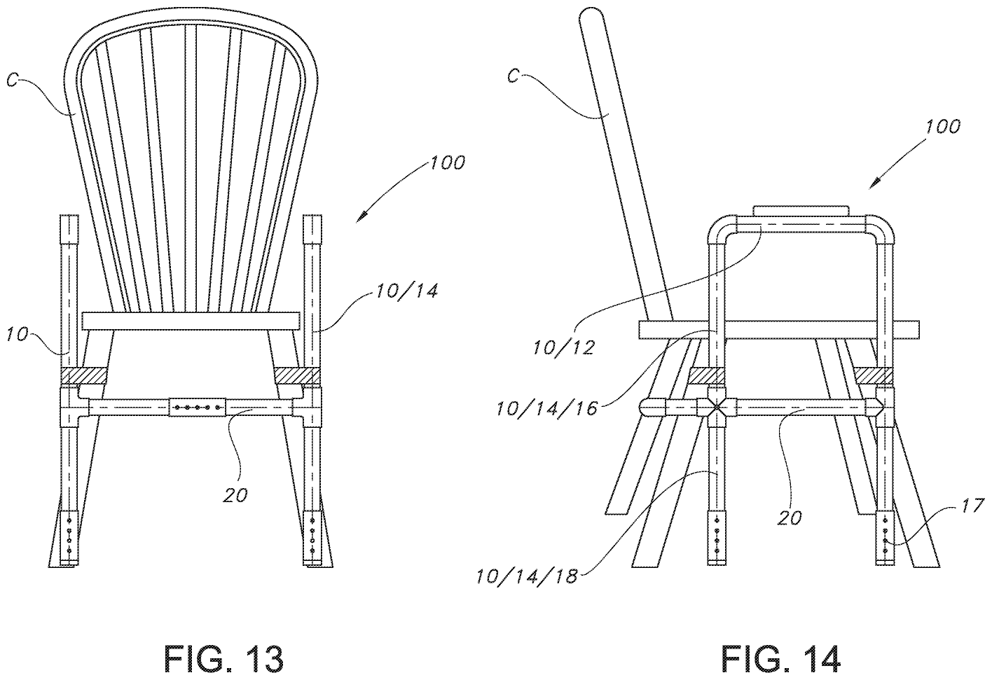

FIG. 13 illustrates the device 100 having an adjustable support bar 20 connecting the rear legs 14. Here, the device 100 is connected to the chair C using straps 22, and the support bar 20 is hingedly attached to the legs 10 so as to increase the portability of the device when it is not in use.

FIG. 14 illustrates the device 100 having support bars 20 connecting the side legs 14, and the support members 10 being connected to the chair C by straps 22, and having feet 17 that are adjustable in length. The adjustable fee 17 are constructed and adjusted using conventional means.

It is understood that the embodiments described herein are merely illustrative of the present invention. Variations in the construction of the portable assistive device may be contemplated by one skilled in the art without limiting the intended scope of the invention herein disclosed and as defined by the following claims.

What is claimed is:

1: A portable assistive device adapted to attach to a chair, the portable assistive device comprising:
at least two support members, each support member having at least two legs that are connected by a top connector, at least one of the at least two support members being removably attachable to each side of the chair;
wherein the at least two support members have a height that is greater than the height of a seat portion of the chair;

2: The portable assistive device of claim 1, wherein the support members are adjustable in height.

3: The portable assistive device of claim 1, wherein the support members are coupled together.

4: The portable assistive device of claim 3, wherein the support members are coupled together by one or more cross bars.

5: The portable assistive device of claim 4, wherein the one or more cross bars are adjustable in width.

6: The portable assistive device of claim 3, wherein at least one cross bar couples the support members together in front of the chair by extending from one of the legs of one of the support members to one of the legs of one of the other support members.

7: The portable assistive device of claim 3, wherein at least one cross bar couples the support members together from behind the chair by extending from one of the legs of one of the support members to one of the legs of one of the other support members.

8: The portable assistive device of claim 1, wherein the support members at least two legs are coupled together.

9: The portable assistive device of claim 1, further comprising attachment mechanisms that removably attach the support members to the chair.

10: The portable assistive device of claim 9, wherein the attachment mechanisms are straps with hook and loop fasteners.
